(19) United States
(12) Patent Application Publication
(10) Pub. No.: US 2021/0264365 A1
(43) Pub. Date: Aug. 26, 2021

(54) Customer Interaction Architecture

(71) Applicant: Wells Fargo Bank, N.A., San Francisco, CA (US)

(72) Inventors: Dennis Emmanuel Montenegro, Concord, CA (US); Michael Dodds, San Francisco, CA (US)

(21) Appl. No.: 14/926,748

(22) Filed: Oct. 29, 2015

Related U.S. Application Data
(60) Provisional application No. 62/200,724, filed on Aug. 4, 2015.

(51) Int. Cl. G06Q 10/10

(52) U.S. Cl. CPC G06Q 10/101

(57) ABSTRACT

A customer interaction architecture includes a customer interaction diagram and interaction specifics. Stakeholders utilize the customer interaction architecture to create customer interaction diagrams describing business and technological components of a customer need. Each step and component in the customer interaction diagram can include one or more drill down diagrams that include additional details. Some drill-down diagrams can show the interaction and relationship between system components. The customer interaction architecture can additionally highlight each step in the customer interaction diagram and debug the diagram for missing or incomplete steps or elements. Various business, technical, and miscellaneous notes and requirements can also be added to the customer interaction diagram and the drill-down diagrams.

### BACKGROUND

Many consumers interact with a product and the company producing that product in various channels. For example, a consumer might enter a physical store to buy the product, visit the company's social media website, and call customer service to address a problem. Before those products reach the marketplace, customer products and services development teams often work in tandem. Such development teams often create task lists and product descriptions to help drive the creation process, and meet regularly to discuss the progress each team is making in the project. As consumer feedback is received, the product and these interactions can be continually revised.

### SUMMARY

Embodiments of the disclosure are directed to an architecture for designing a customer-facing product. The architecture includes a diagram with a customer-facing portion and a back office portion.

In one aspect, a method for diagramming a customer interaction with a product includes populating a diagram with at least one selectable icon representing one or more touchpoints, generating at least one customer interactions on a first portion of the diagram, where the customer interactions are between a customer and the product via the one or more touchpoints, on a second portion of the diagram, generating a flow of back-office interactions corresponding to the one or more steps of customer interactions on the first portion of the diagram, and, initiating by a computing device a playback sequence highlighting the one or more steps of customer interactions sequentially.

In another aspect, an electronic computing device includes a processing unit and a system memory, where the system memory includes instructions that, when executed by the processing unit, cause the electronic computing device to display a customer need diagram that includes one or more touchpoints, a customer interaction portion including one or more customer interaction steps, and a back office interaction portion including one or more back office interaction steps. The system memory also includes instructions that, when executed by the processing unit, cause the electronic computing device to, when a user selects a play control, display a playback progression of steps and, when the user selects a drill-down control, display a drilled-down view.

In another aspect, a computer-readable data storage memory includes instructions that, when executed by a processing unit of a first electronic computing device, causes the processing unit to display a customer interaction diagram, display a playback sequence when a playback request is received, and display a drilled-down view when a drill down request is received. The customer interaction diagram includes a first portion including one or more customer interaction steps, a second portion including one or more back office interaction steps, at least one customer channels positioned along an interface between the first portion and the second portion, a customer need portion, a customer, and at least one customer-channel line connecting the customer to the at least one customer channel.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows a schematic block diagram for an example system for creating a customer interaction diagram.

FIG. 2 shows a schematic hierarchy of an example customer interaction architect.

FIG. 3 shows an example customer interaction architecture.

FIG. 4 shows an example populated customer interaction diagram.

FIG. 5A shows an example dynamic drill-down diagram.

FIG. 5B shows an example static drill-down diagram.

FIG. 6 shows an example code details drill-down diagram.

FIG. 7 shows an example method for creating a customer interaction diagram.

FIG. 8 shows example physical components of a computing device hosting the customer interaction diagram of FIG. 1.

### DETAILED DESCRIPTION

The present disclosure is directed to systems and methods for developing a customer-facing product. One consideration when designing a customer-facing product is to identify the flow of the customer's experience and interactions with the product via various channels. For example, the customer might access the product online, through a mobile computing device application, in a physical store, on the telephone, and/or with a stand-alone machine such as an automated teller machine (“ATM”) or vending machine. The channels can also include back office elements that may be needed to operate and interact to provide the customer with the experience desired by the entity creating the product. With each added channel and touchpoint, developing the consumer product becomes more complex. The instant disclosure describes an architecture for improving organizing and coordinating the multiple touchpoints between the customer and the product.

One or more system users can use the architecture to create a visualization of customer and back office flows using a combination of stored icons, system flows and elements, as well as freeform text. A diagram provided in the disclosed systems and methods can include selectable customer touchpoints with the product and/or entity developing the product. One portion of the diagram can show customer interactions, and a second portion can show the back office interactions. The resulting diagram is organic and dynamic: steps and text can be added, edited, or modified, playback of the steps is possible, and one or more steps can be further drilled-down to reveal additional details.

The organic, dynamic diagram provides a more efficient way for cross-functional team members to develop a customer-facing product. Additionally, the dynamic diagram provides a more efficient way to view and compile multiple components of a customer-facing product. For example, the architecture and diagram enable one or more users to efficiently evaluate each step, drill down and learn more about particular steps or sub-processes, and troubleshoot for missing components or steps.

Diagrams produced using the disclosed systems and methods are accessible by the various stakeholders in the product development, such as business agents and computer technology agents. Further, the diagram's presentation can facilitate in understanding the “big picture,” and the architecture can identify missing components. After product launch, revisions to the diagram can be made based on testing, product performance, critical reviews, and customer feedback.

The systems and methods disclosed herein are applicable to many different types of products and industries, particularly in a consumer product or service industry. For example, these systems and methods can be used to design a consumer electronic product, a healthcare product, a financial product, and any product that includes a customer-facing aspect and a back office aspect.

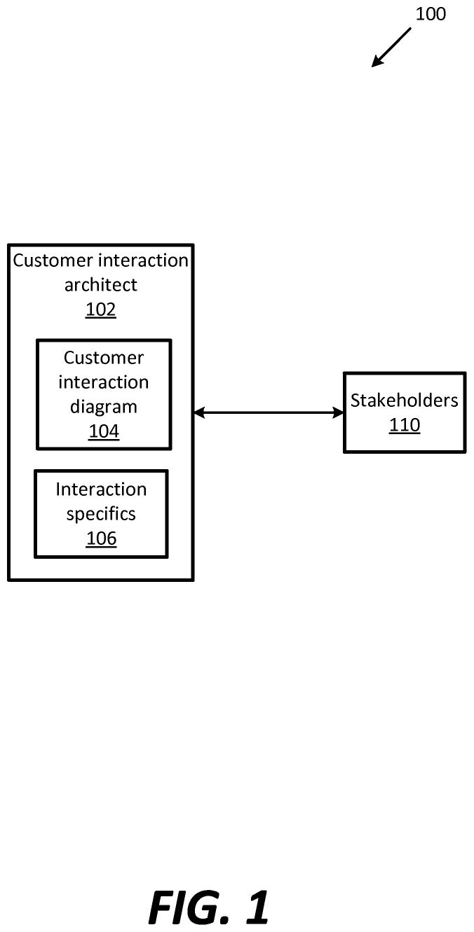

FIG. 1 shows an example system 100 for creating a customer interaction diagram (CID) of a consumer product. The consumer product can be a service, physical product, or computer application, to name a few examples. The example system 100 includes a customer interaction architecture 102 and one or more stakeholders 110. The customer interaction architecture 102 includes a customer interaction diagram 104 and interaction specifics 106. Other embodiments can include more or fewer components.

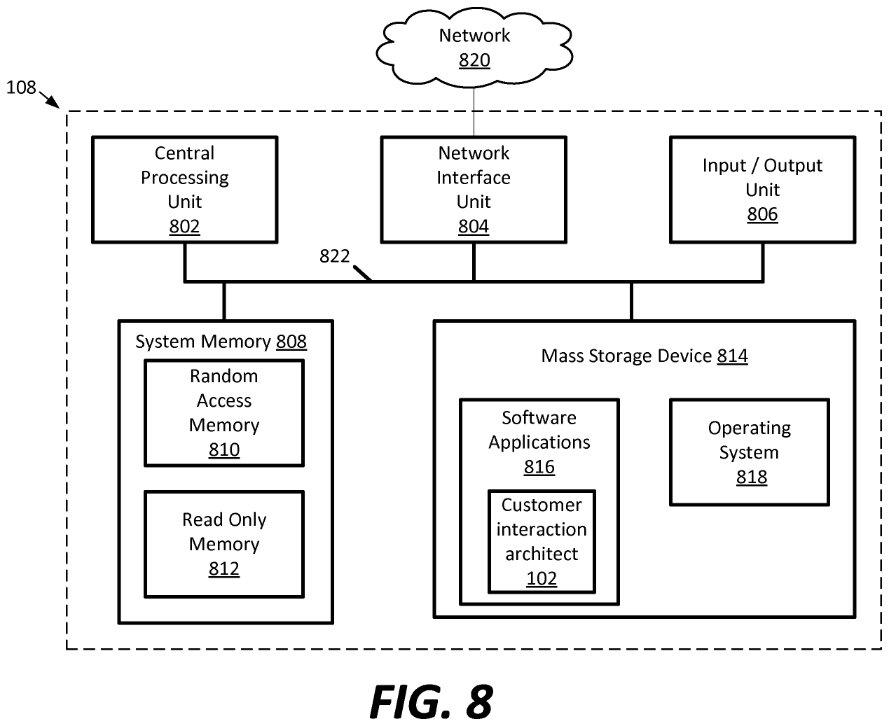

In the example system 100, the customer interaction architecture 102 is an executable file stored locally or on a cloud-based server 108 (shown in FIG. 8). In other embodiments, the customer interaction architecture 102 is an internet application that is loaded within a web browser. Thus, stakeholders 110 can access the customer interaction architecture 102 via a locally-stored executable file and/or via a web browser, such as Google Chrome, Microsoft Internet Explorer, or Mozilla Firefox. The web application can use HTML5, CSS3, JavaScript, or other programming languages.

Stakeholders 110 include employees or contractors of the entity developing the customer product. The stakeholders 110 can create, save, retrieve, share, and edit individual CIDs. Stakeholders 110 can also visually play back the sequence of steps in a CID, drill-down into steps of the CID, link elements in a CID to related content, export the CID to an image file format, and manage an inventory of CIDs.

The example customer interaction architecture 102 includes a customer interaction diagram 104. The customer interaction diagram 104 depicts business and technical components of a consumer product. Stakeholders 110 can use the customer interaction diagram for ideation, design and development of a consumer product. Additionally, multiple stakeholders 110 can access and edit the same CID to provide the capability for collaboration, including collaboration across teams within an organization. Example customer interaction diagrams 104 are described below in more detail.

The example customer interaction architecture 102 also includes interaction specifics 106. Interaction specifics 106 include additional details about elements or steps within the customer interaction diagram 104. The interaction specifics 106 are drilled-down views or exploded views that show the sub-parts of the systems or steps involved, and can show the interplay among those systems or steps. In software implementations, interaction specifics 106 includes detailed and integrated views of the software used to realize the requirements or actions shown in the customer interaction diagram 104. Interaction specifics 106 can additionally include links to test cases and test results. Examples of interaction specifics 106 are described below in more detail.

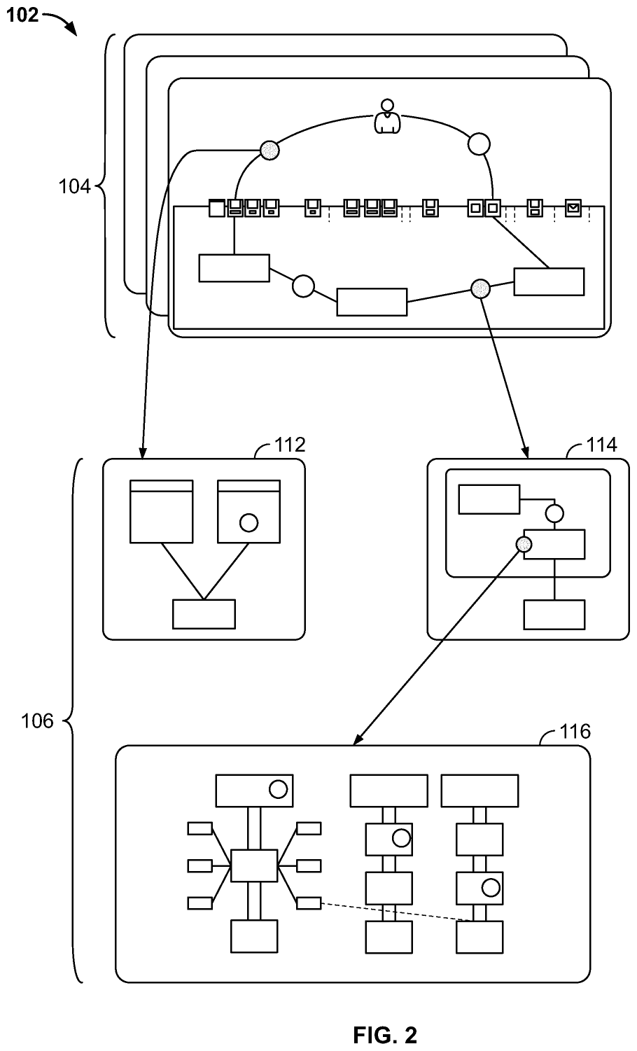

FIG. 2 shows a schematic hierarchy of the parts and sub-parts of an example customer interaction architecture 102. The hierarchy shows a customer interaction diagram 104 and interaction specifics 106. The interaction specifics 106 optionally include drill-down diagram 112 from a business portion and optional drill-down diagram 114 from a back office portion.

The drill-down diagram 112 from a business portion can include the flow of a customer/user experience, for example, the sequence of screens shown to a customer or user. The back office drill-down diagram 114 can include a link to a code details drill-down diagram 116. Each is described in more detail below.

Each diagram 104, 112, 114, and 116 can include notes (i.e., added descriptions for various fields) and/or requirements (i.e., various required functionalities). A stakeholder 110 can add different types of requirements anywhere in the diagrams using pop-up/dialog boxes. Example types of requirements include a business requirement, a technical requirement, and a miscellaneous requirement. The requirements can be in the form of text, tables, links, or mini-diagrams.

Requirements in the customer interaction diagram 104 can list impacted systems, include business or technical rules, snippets of logic, links to other documents, etc. Requirements in the drill-down diagrams 112 and 114 can include business or technical rules, which can include snippets of logic, links to other documents, such as customer/user experience specifications and screen designs, design documents by other groups, etc.

Requirements in the code details drill-down diagram 116 can include notes taken while drafting or interpreting the code, and notes in places where the code needs additions or changes for a particular project/consumer product. These notes can serve as a to-do list for developers and testers. A tool that mines code (e.g., a lexicographic scanner) and automatically populates code in the code details drill-down diagram 116 can be repeatedly re-run as the code is delivered, and the updated results can be compared to the to-do list.

The customer interaction architecture 102 can also parse and collect the requirements into a single list or page. The collected requirements list can include version numbering and change history to provide an audit trail. The list can sort by, for example, requirement type or corresponding diagram.

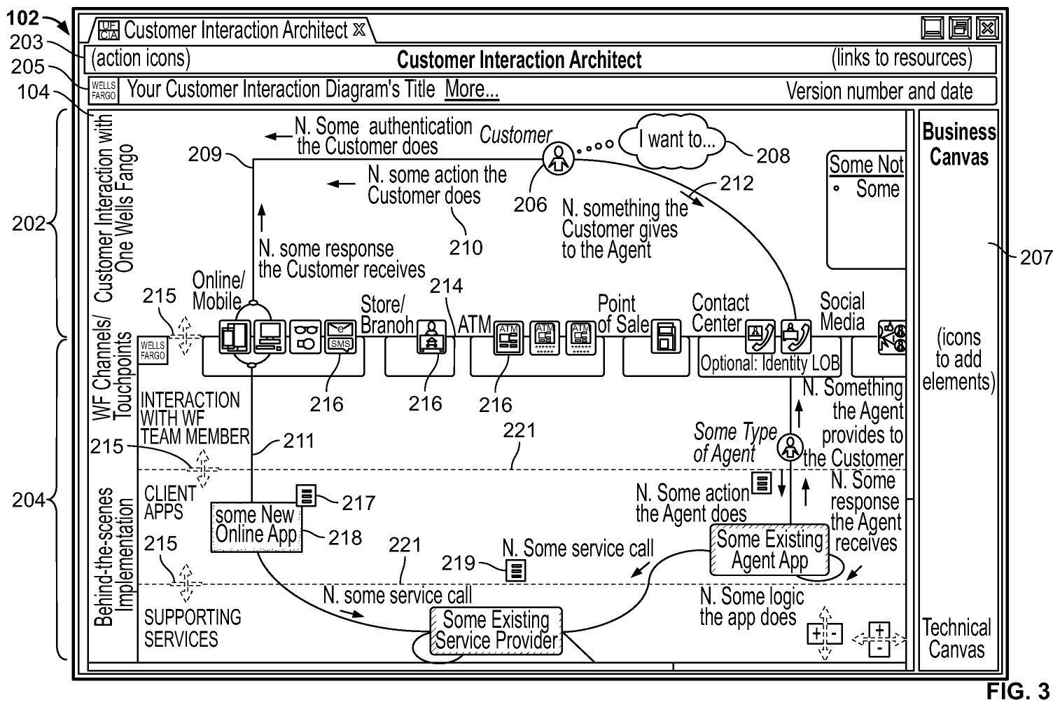

FIG. 3 shows an example customer interaction architecture 102. Generally, the example customer interaction architecture 102 includes a customer interaction diagram 104 with a business portion 202 and a back office portion 204, and peripheral functional areas 203, 205 and 207. The components of each are described below. The example customer interaction diagram 104 is one possible depiction of what the diagram 104 would look like after a user initiates the customer interaction architecture 102 on a web browser or from a locally-stored version. Other embodiments can have different orientations of the components than that shown in FIG. 3.

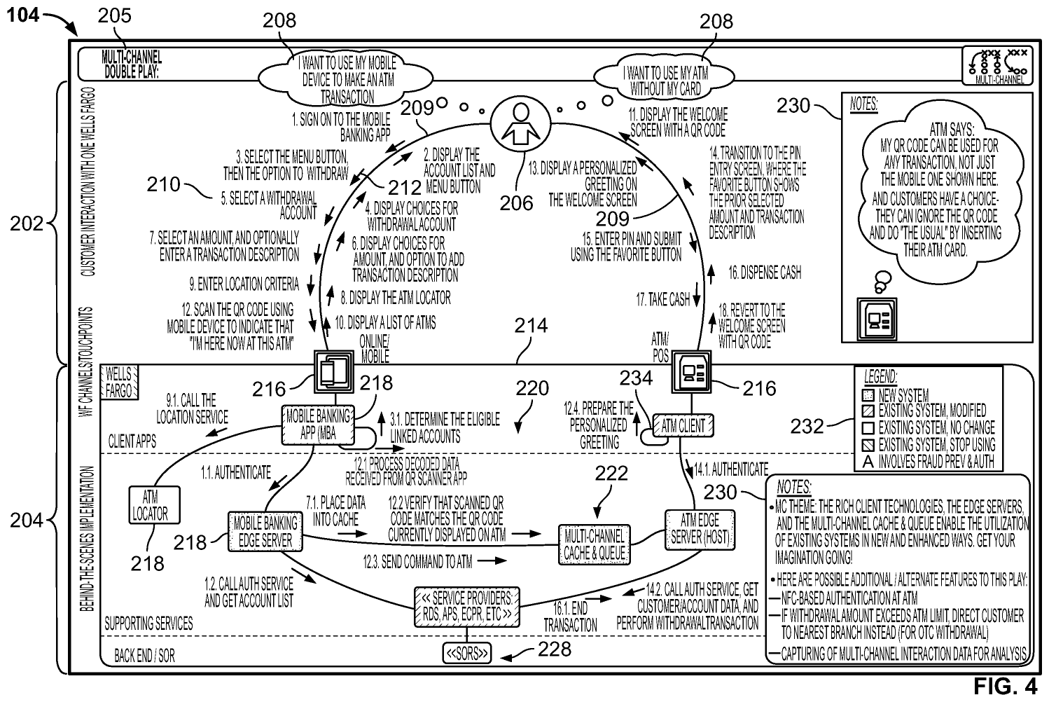

An example of a customer interaction diagram 104 that has been partially or completely finished is shown in FIG. 4 and described in detail below. Other embodiments can include more or fewer components. The artifacts comprising these diagrams can be collected into reference documentation that can be made available to stakeholders for access and editing by stakeholders and members of the project/product team.

A navigation pane 203 is positioned near the top of the example customer interaction architecture 102. The navigation pane 203 includes action items and resources, which can be displayed as menus or icons. Examples of action items include: return to CID inventory, new CID, open CID, save CID, save as, print, export as image, play from beginning, next step, and previous step. Examples of resources include: CID tutorial, help, contact us, and feedback.

The playback feature automatically progresses through the steps in the customer interaction diagram 104. Manual control of playback is possible. During playback, a spotlight points to a single step and moves as the sequence of steps is traversed. The spotlight can be a shape appearing around the step, such as a square, circle, or oval, or an alteration of text, such as bolding, highlighting, or a change of color. Any notes for the highlighted step can also appear, as well as any hyperlinks to drill-down diagrams, documents stored locally or on a network or cloud server, or internet links. As shown in the embodiment of customer interaction diagram 104, the steps are not necessarily adjacent to the previous and next steps; thus, the playback with highlight option assists a viewer with locating each step in the sequence.

In embodiments, canvas 207, discussed in more detail below, can list each step 210. The steps in canvas 207 are highlighted to match the spotlight. Selecting a step in canvas 207 causes the spotlight to transition to that step accordingly. Each step can include options to expand the step to see notes for that step, to view a drill-down diagram (if one exists), and to navigate via hyperlink to any related documentation.

As the playback progresses, the customer interaction architecture 102 determines the placement of the spotlight based on the step numbering. If a stakeholder 110 alters the sequence of steps, the customer interaction architecture 102 adapts and follows the altered sequence the next time the diagram is played back.

An optional feature is that the customer interaction architecture 102 pauses playback and provides a warning if steps are missing or need debugging. An example is when an application is present in the back office portion 204, and the application requires logging in, but the business portion 202 does not include a user id/login step. The customer interaction architecture 102 can allow editing on the spot, which can be followed by playback resumption. A stakeholder 110 can also override the warning.

Below the navigation pane 203 is an information pane 205. The information pane 205 can include: the CID title, embedded notes, CID version number and date, and architecture version number. A stakeholder 110 can add and edit information in the information pane 205.

The customer interaction architecture 102 also includes a canvas 207 including elements for populating the customer interaction diagram 104. The canvas 207 includes elements that can be used in both the business portion 202 and the back office portion 204. Example elements include: thought bubble, customer, agent, note, blue line, blue text/step, gray line, gray text, new system, existing system (modified), existing system (no changes), existing system (stop using), and legend. The elements can be dragged and dropped into the customer interaction diagram 104. Added steps can have automatically-generated numbers.

The lines and text can be color coded to correspond to different stakeholder groups or actions, where the different stakeholder groups or actions are indicated in a legend. For example, in the business portion 202, the lines 209 and action item steps 210 in blue indicate customer- and agent-facing interactions. Also, as an example, in the back office portion 204, the lines 211 and action item steps 210 in gray depict system interactions.

As shown, the customer interaction diagram 104 divides the business portion 202 from the back office portion 204 along a horizontal line, the interface 214. However, other orientations are possible, such as having the interface 214 run vertically, with the business portion 202 and the back office portion 204 occupying the left and right sides of the customer interaction diagram 104 rather than the top and bottom of the customer interaction diagram 104 as shown in FIG. 3.

As stakeholders populate the customer interaction diagram 104, it can become larger than the screen size, in the horizontal and/or vertical direction, and one or more scroll bars can appear to enable stakeholders 110 to view the entire customer interaction diagram 104. The customer interaction diagram 104 can also include a button or tools for altering the zoom or overall size of the diagram.

The business portion 202 includes a depiction of the steps of a customer's interaction with the product. In the embodiment shown, the business portion includes little or no technical details about the product. The business portion 202 can include the requirements, from a business, marketing, or non-technical point of view, for the product. For some products, an analogy could be made that the business portion is the “front of house” in a restaurant.

The business portion 202 includes a customer 206, customer need 208, action item text 210, and directional arrows 212. The customer need 208 can appear as a thought bubble near the customer 206. One or more lines 209 extend from the customer 206 to various touchpoints 216 located along the interface 214 between the business portion 202 and the back office portion 204. In this embodiment, lines 209 that include steps that involve the customer receiving or providing something are blue.

Text 210 indicates an action item and has a color corresponding to the line 209 color. Each text 210 item is numbered automatically, although stakeholders 110 can modify the numbering. In other embodiments, automatic numbering can be disabled.

When a stakeholder 110 selects an action item text 210 box, a menu appears. The menu can include: edit text, change font size, add notes, and create hyperlink. The text 210 box can be resized. Adjacent to the text 210 are directional arrows 212 indicating the direction of data flow.

An interface 214 separates the business portion 202 and the back office portion 204. Various touchpoints 216 are populated along the interface 214. The touchpoints 216 can automatically populate upon program initiation or a stakeholder 110 can add them by dragging and dropping from the canvas 207. Example touchpoints include: mobile phone, tablet computer, desktop computer, smart glasses, smart watch, text message (SMS), store, satellite machine (e.g., ATM or vending machine), point of sale, contact center (automated), contact center (human operator), social media, physical product, etc. The touchpoints 216 can be grouped by type, such as store, point of sale, social media, mobile device, etc. In embodiments, the touchpoints 216 can only be moved along the interface 214 (horizontally in the embodiment shown).

The position of the interface 214 can be adjusted using a button 215. Changing the interface 214 alters the relative sizes of the business portion 202 and the back office portion 204.

The customer interaction diagram 104 also includes a back office portion 204. The back office portion 204 includes the technical requirements and steps to support the customer interactions shown in the business portion 202. The back office portion 204 can also include depictions of one or more systems needed to accomplish the steps shown in the business portion 202. Again using a restaurant analogy, the back office portion 204 is like the kitchen in a restaurant that is usually out-of-sight for the customer.

The back office portion 204 includes one or more subsections separated by dashed lines 221 and people, applications, and hardware, plus corresponding text and directional arrows. Example subsections include: interaction with entity employee, client applications, support services, and back end system resources. The relative sizes of the subsections can be adjusted using buttons 215.

Lines 211 connect steps or elements, and in this embodiment, gray lines indicate that information is being sent or received between the touchpoints 216 and back office elements 218 or between back office elements 218. Some lines 211 can form loops that start and end at the same app or hardware.

When a stakeholder 110 adds a step or element, the customer interaction architecture 102 can be configured to offer a set of choices. For example, in addition to allowing freeform text entry, the stakeholder 110 receives a set of choices based on context (e.g., after adding an online touchpoint, “sign on/log in” is suggested) and/or history, where the customer interaction architecture 102 can learn over time choices to suggest based on prior diagrams.

FIG. 4 is an embodiment of example customer interaction diagram 104, where the diagram 104 has been edited. The edited customer interaction diagram 104 includes many of the features discussed with reference to FIG. 3, above. The example customer interaction diagram 104 shown in FIG. 4 diagrams a product enabling a customer to use an ATM without their card and using their mobile device. However, to reiterate, the example customer interaction diagram 104 can be used in many different industries and for many different types of products and services. The information pane 205 includes the title of the customer interaction diagram 104: “Multi-Channel Double Play.”

The example customer interaction diagram 104 includes a business portion 202 and a back office portion 204. The business portion 202 includes a customer 206, customer needs 208, action item text 210, and directional arrows 212, to name a few features. Interface 214 separates the business portion 202 and the back office portion 204, and one or more touchpoints 216 are positioned on the interface 214. The back office portion 204 includes a client applications section 220 with elements 218 such as apps, a supporting services section 222 with elements 218 such as software and hardware, and back end section 228. In other embodiments, the back office portion 204 includes a personnel section, not shown in FIG. 4. Other embodiments can include more or fewer components.

In the embodiment of customer interaction diagram 104 shown in FIG. 4, eighteen steps 210 are involved in a customer 206 conducting a transaction with an ATM. Each step 210 is numbered and each step has a directional arrow 212 to indicate the direction of information flow. For this customer need, the customer interaction diagram 104 includes two touchpoints 216: online/mobile and ATM/point-of-sale. Lines 209 connect the customer 206 to each touchpoint 216.

Some of the action item steps 210 in the business portion 202 have corresponding steps in the back office portion 204. The corresponding steps in the back office portion 204 describe the actions of the back office components during the step described in the business portion 202. These corresponding steps can use some type of notation to indicate correspondence, for example, the following notations, with subsequent numbering, could be used for back office operations corresponding to step 1: “1.1”, “1.a”, “1.A”, etc.

An example of corresponding steps in embodiment of customer interaction diagram 104 is step 1, “sign on to mobile banking app.” In the business portion 202, the mobile banking app communicates with the mobile banking edge server, and step 1.1 is to authenticate. Step 1.2 is for the mobile banking edge server to call the authorization service and get the account list.

The customer interaction diagram 104 also includes notes 230 in the business portion 202 and in the back office portion 204. The note 230 in the business portion 202 includes additional description of the ATM touchpoint 216. The note 230 in the back office portion 204 includes additional or alternative features that can be added. Notes 230 can also be embedded with the steps or elements in the customer interaction diagram 104. Other embodiments can include more or fewer notes.

The embodiment of customer interaction diagram 104 includes multiple loops 234. The loops 234 start and end at the same element. The loops 234 are in contrast to the lines that start at one element and go to a different element.

When a line 209, step 210, or element 218 is selected, the customer interaction diagram 104 displays any notes or hyperlinks associated with the line 209, step 210, or element 218. The action item steps 210 can additionally include an indicator that more details are available via a drill-down diagram.

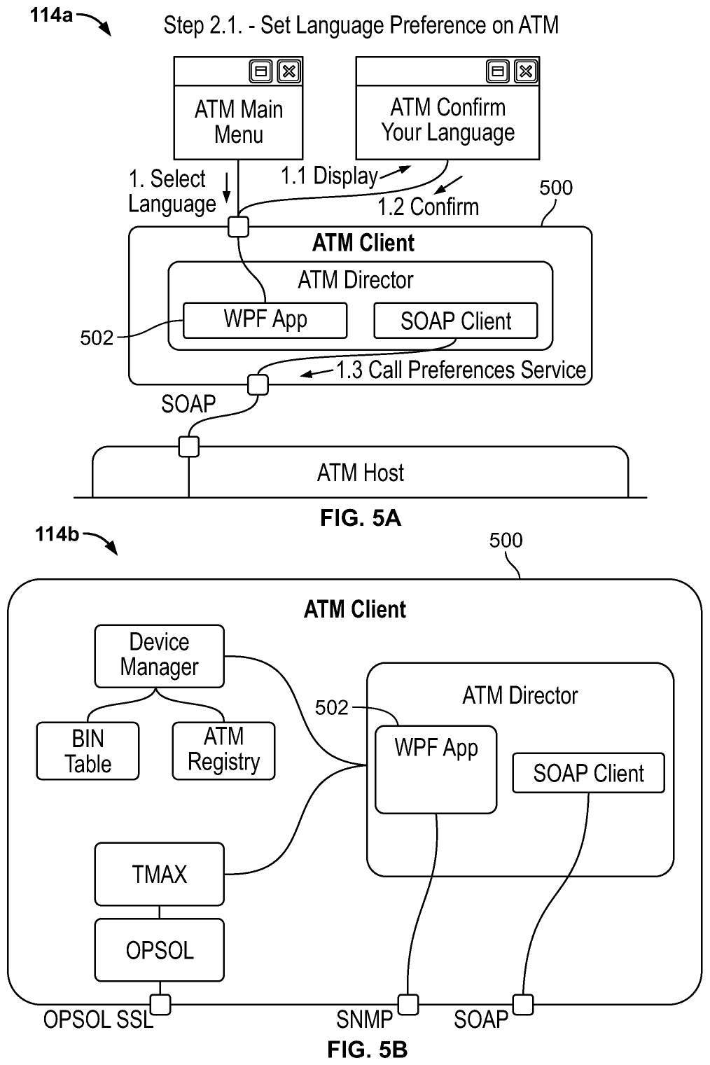

FIGS. 5A and 5B show examples of, respectively, a dynamic drill-down diagram 114a and a static drill-down diagram 114b. Generally, drill-down diagrams can be added to a customer interaction diagram 104 and contain additional details and/or components necessary to fulfill a step in the customer interaction diagram 104. The drill-down diagrams 114a and 114b can include the playback and spotlight features discussed above.

FIGS. 5A and 5B are example each drill-down diagrams 1 for “Step 2.1: set language preference on ATM.” The customer interaction architecture 102 can be programmed to display one or both of these diagrams 114a and 114b when a user selects a drill-down hyperlink.

The dynamic drill-down diagram 114a shows the same component 500 as the static drill-down diagram 114b. The static drill-down diagram 114b shows software and/or hardware components, their interconnections, and the modules through which the components interface with other systems. The dynamic drill-down diagram 114a shows the same components interacting with each other in order to fulfill a step in the customer interaction diagram 104, including steps and directional arrows. For example, dynamic drill-down diagram 114a shows the screen flow and the corresponding calls between system components and subcomponents.

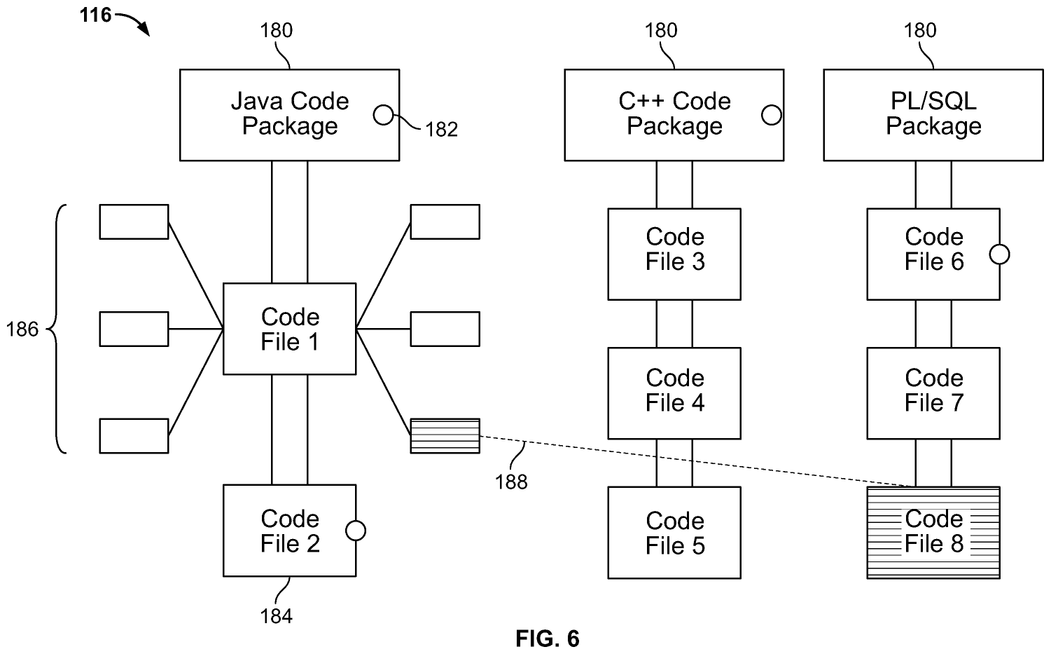

An optional feature is for a component to hyperlink to a code details drill-down diagram 116. For example, the application 502 includes a hyperlink to the drill-down diagram shown and described in more detail with reference to FIG. 6.

FIG. 6 shows an example code details drill-down diagram 116. The example code details drill-down diagram 116 includes code files, e.g. classes, grouped by logical package in a columnar layout. Other layouts are possible. The example code details drill-down diagram 116 is accessible via hyperlink from either the customer interaction diagram 104 and/or the drill-down diagram 114. The example code details drill-down diagram 116 includes logical packages 180, notes 182, code files 184, a view other calling code files 186, and a related files indicator 188 in home packages.

When a stakeholder 110 selects an object for code drill down, a tool lists the code files related to the object and groups them by logical package 180. In the example shown in FIG. 6, three code packages are related to the object in the drill-down diagram 114. Each package has a link to a “search listing” page and a link to a “comments extract” page, which helps promote proper commenting.

In order to generate the code details drill-down diagram 116, a tool can pull from a code repository and generate pages on a team site, where access to the team site can be controlled accordingly. This can save stakeholders 110 from having to load the code into an integrated development environment (IDE). Programming languages that can be supported by this tool include COBOL, Java, C++, C#, and PL/SQL.

The code details drill-down diagram 116 can also include notes 182. In the notes 182, stakeholders 110 can include messages to other stakeholders 110, explanations, possibilities for extension or alternatives, etc. Notes in the code details drill-down diagram 116 can be collated into a task or to-do list, which can serve as a technical specification for a customer product. In embodiments, all code details drill-down diagrams for the customer interaction diagram 104 can be collated into the to-do list. The code-loading tool discussed above can be re-run whenever new code is delivered.

The code file 184 includes a link to a page that includes a full code listing with hyperlinks to related code files, as well as dead code indicators. These pages can open in a separate window or browsing tab, or can appear as a pop-up within the customer interaction architecture 102.

The code file 184 additionally can include an option to view other calling code files 186 that call it, as well as the other files that it calls, which can be indicated with directional arrows. Also, a visual indicator 188 identifies, links, and displays related files in their home packages. Selecting the indicator or link can call up the related files into the code details drill-down diagram 116 if the files are not already shown within the code details drill-down diagram 116.

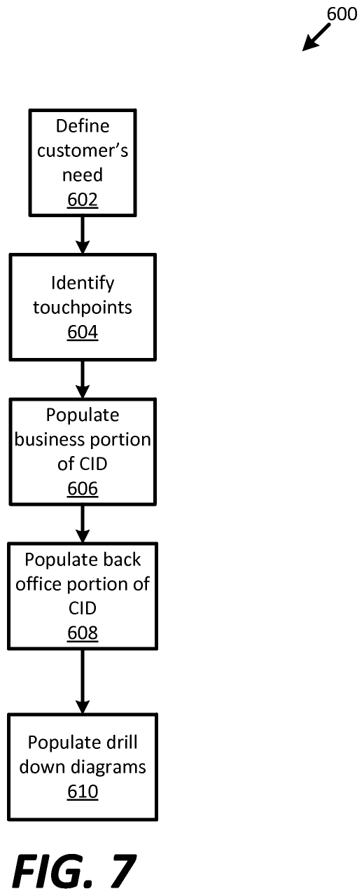

FIG. 7 is a block diagram of an example method 600 of creating a customer interaction diagram (CID). Generally, the CID shows both the business requirements and technical design that will fulfill a customer need. The example method 600 includes defining a customer's need (operation 602), identifying touchpoints (operation 604) populating the business portion of a CID (operation 606), populating the back office portion of a CID (operation 608), and populating drill down diagrams (operation 610). The order can be different in other embodiments. Other embodiments can include more or fewer operations. One or more stakeholders can complete the various operations and completion can occur at different times.

The example method 600 begins by identifying a customer's need (operation 602). In other embodiments, the example method 600 begins by defining a particular customer product or service. In the example customer interaction diagram 104, this need or product is described in the thought bubble 208.

After defining the customer need (operation 602), the touchpoints or channels are next identified (operation 604). The CID designer adds lines connecting the customer to each of touchpoint on the interface between the business portion and the back office portion. In embodiments, after a touchpoint is placed on the interface the customer interaction architect automatically connects the customer and the touchpoint. The customer interaction architect can also suggest additional touchpoints based on one or more touchpoints that have been added.

Next, the business portion of the CID is populated (operation 604). Generally, a business owner, analyst, marketing professional, or other type of employee populates the business portion of the CID. As discussed above, the business portion can include a customer, connecting lines, steps, directional arrows, customer need, notes, requirements, menus, and hyperlinks. The customer interaction architect can provide one or a series of dialog boxes regarding each element that has been added to the diagram. For example, when a stakeholder adds a step, the customer interaction architect can query for the informational flow direction, the color of the text, the text numbering, any hyperlinks that should be added, any notes that should be added, and any requirements that should be added.

After one or more steps have been added (operation 604), the back office portion of the CID is next populated. Generally, a stakeholder with at least minimal technical competence populates the back office portion of the CID. As discussed above, the back office portion includes the systems used in, and impacted by, the steps shown in the business portion.

After some or all of the business and back office portions have been populated (operations 606 and 608), the drill down diagrams are next populated (operation 610). Similar to operation 606, a business owner, analyst, marketing, or other employee can add diagrams in the business portion drill-down diagram. These diagrams show, for example, a customer/user experience, the flow of screens in a computer-based implementation, or business or miscellaneous requirements.

For the back office drill-down diagrams, typically an architect, developer, or other technically-savvy stakeholder adds diagrams showing system internal components, systems interactions, or technical or miscellaneous requirements. Generally, a developer or other technically savvy stakeholder initiates the code populating tool to run, on-demand or as part of the build process. Then the stakeholder adds technical or miscellaneous requirements to the results from the tool. These requirements can serve as a to-do list or technical specifications. Then, subsequent results from the tool can be used for code review and comparison vis-à-vis the to-do list and technical specification. A tester or other technically-savvy stakeholder adds technical or miscellaneous requirements, including links to test cases and test results.

FIG. 8 shows an example server 108 hosting the customer interaction architecture 102. As illustrated, the example server 108 includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the example server 108, such as during startup, is stored in the ROM 812. The example server 108 further includes a mass storage device 814. The mass storage device 814 is able to store software instructions and data.

The mass storage device 814 is connected to the CPU 802 through a mass storage controller (not shown) connected to the system bus 822. The mass storage device 814 and its associated computer-readable data storage media provide non-volatile, non-transitory storage for the example server 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the example server 108.

According to various embodiments of the invention, the example server 108 may operate in a networked environment using logical connections to remote network devices through the network 820, such as a wireless network, the Internet, or another type of network. The example server 108 may connect to the network 820 through a network interface unit 804 connected to the system bus 822. It should be appreciated that the network interface unit 804 may also be utilized to connect to other types of networks and remote computing systems. The example server 108 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the example server 108 can store software instructions and data. The software instructions include an operating system 818 suitable for controlling the operation of the example server 108. The mass storage device 814 and/or the RAM 810 also store software instructions, that when executed by the CPU 802, cause the example server 108 to provide the functionality of the example server 108 discussed in this document. For example, the mass storage device 814 and/or the RAM 810 can store software instructions that, when executed by the CPU 802, cause the example server 108 to display received data on the display screen of the example server 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for diagramming a customer interaction with a product, comprising:
populating a diagram with one or more selectable icons representing one or more touchpoints;
generating one or more steps of customer interactions on a first portion of the diagram, wherein the customer interactions are between a customer and the product via the one or more touchpoints;
on a second portion of the diagram, generating a flow of back-office interactions corresponding to the one or more steps of customer interactions on the first portion of the diagram;
initiating, by a computing device, a playback sequence highlighting the one or more steps of customer interactions sequentially;
analyzing, by the computing device, the one or more back office interaction steps to yield an analysis; and
based on the analysis, populating one or more drilled-down views, wherein the drilled-down views include at least one source code drill-down diagram including:
a visual depiction of logical source code package with a link to software development source code files associated with the logical source code package, with each of the software development source code files being depicted on the at least one source code drill-down diagram;
a visual depiction of view other calling code files link to view other files that call the logical source code package, with each of the other calling code files being depicted on the at least one source code drill-down diagram;
indicators extending between each of the software development source code files and the other calling code files that are displayed on the at least one source code drill-down diagram, wherein terminations of the indicators visually depict relationships therebetween; and
a related files indicator link to other files related to the logical source code package.

2. The method of claim 1, further comprising populating at least one detailed view diagram from a parent representation,
wherein the parent representation is selected from: the one or more selectable icons representing one or more touchpoints, the one or more steps of customer interactions, and the flow of back-office interactions.

3. The method of claim 2, further comprising initiating an automatic populating of one or more additional selectable icons based on the one or more selectable icons representing one or more touchpoints.

4. The method of claim 3, wherein the one or more selectable icons representing one or more touchpoints are positioned at an interface between the first portion and the second portion.

5. The method of claim 1, further comprising populating the diagram with a customer need.

6. The method of claim 5, further comprising analyzing the one or more selectable icons and the one or more steps of customer interactions to determine whether steps or components are missing or need correction, wherein said analyzing occurs during the playback sequence.

7. The method of claim 6, further comprising adding at least one requirement to the diagram, the at least one requirement selected from: a business requirement, a technology requirement, or a miscellaneous requirement.

8. An electronic computing device comprising:
a processing unit; and
system memory, the system memory including instructions that, when executed by the processing unit, cause the electronic computing device to:
display a customer need diagram, including:
one or more touchpoints;
a customer interaction portion including one or more customer interaction steps; and
a back office interaction portion including one or more back office interaction steps;
when a user selects a play control, display a playback progression of steps;
when the user selects a drill-down control, display a drilled-down view;
analyze the one or more back office interaction steps to yield an analysis;
based on the analysis, populate one or more drilled-down views, wherein the drilled-down views include at least one source code drill-down diagram including:
a visual depiction of logical source code package with a link to software development source code files associated with the logical source code package, with each of the software development source code files being depicted on the at least one source code drill-down diagram;
a visual depiction of view other calling code files link to view other files that call the logical source code package, with each of the calling code files being depicted on the at least one source code drill-down diagram; and
related files indicators extending between each of the software development source code files and the other calling code files that are displayed on the at least one source code drill down diagram, wherein terminations of the indicator visually depict relationship therebetween; and
upon selection of one of the related files indicators, generate a request to a code repository to load code associated with the logical source code package into a development environment.

9. The electronic computing device of claim 8, wherein the system memory further includes instructions that, when executed by the processing unit, cause the electronic computing device to:
highlight each step during the playback progression of steps.

10. The electronic computing device of claim 9, wherein the system memory further includes instructions that, when executed by the processing unit, cause the electronic computing device to:
automatically populate one or more additional touchpoints based on the one or more touchpoints; and
automatically populate one or more additional back office interaction steps based on the one or more touchpoints.

11. The electronic computing device of claim 9, wherein the one or more touchpoints are positioned at an interface between the customer interaction portion and the back office interaction portion; and
wherein the customer need diagram further comprises a customer need portion.

12. The electronic computing device of claim 11, wherein the system memory further includes instructions that, when executed by the processing unit, cause the electronic computing device to:
analyze the one or more touchpoints, the one or more customer interaction steps, and the one or more back office interaction steps;
determine whether steps or components are missing or need correction; and
if any steps or components are missing or need correcting, suggest a correction.

13. The electronic computing device of claim 12, wherein the customer need diagram further comprises:
one or more customer-touchpoint lines connecting a customer to the one or more touchpoints;
wherein the one or more customer interaction steps are positioned adjacent to the one or more customer-touchpoint lines;
wherein the one or more customer interaction steps are numbered sequentially; and
wherein a directional arrow is positioned adjacent to each of the one or more customer interaction steps.

14. The electronic computing device of claim 13, wherein the customer need diagram further comprises:
at least one requirement to the customer need diagram, the at least one requirement selected from: a business requirement, a technology requirement, or a miscellaneous requirement.

15. (canceled)

16. A computer-readable data storage memory comprising instructions that, when executed by a processing unit of a first electronic computing device, causes the processing unit to:
display a customer interaction diagram, including:
a first portion including one or more customer interaction steps;
a second portion including one or more back office interaction steps;
one or more customer channels positioned along an interface between the first portion and the second portion;
a customer need portion;
a customer; and
one or more customer-channel lines connecting the customer to the one or more customer channels;
display a playback sequence when a playback request is received;
display a drilled-down view when a drill down request is received;
analyze the one or more back office interaction steps and produce an analysis; and
based on the analysis, populate one or more drilled-down views;
wherein the drilled-down views include at least one source code drill-down diagram including:
a visual depiction of logical source code package with a link to software development source code files, with each of the software development source code files being depicted on the at least one source code drill-down diagram;
a visual depiction of view other calling code files link to view other files that call the logical source code package, with each of the other calling code files being depicted on the at least one source code drill-down diagram; and
related files indicators extending between each of the software development source code files and the other calling codes files that are displayed on the at least one source code drill down diagram, wherein terminations of the indicator visually depict relationship therebetween; and
wherein, upon selection of one of the related files indicators, generate a request to a code repository to load code associated with the logical source code package into a development environment.

17. The computer-readable data storage memory of claim 16, wherein the second portion further includes one or more back office components;
wherein the second portion further includes one or more back office lines connecting at least one of the one or more back office components to at least one of the one or more customer channels; and
wherein each customer interaction step and each back office interaction step is highlighted during the playback sequence.

18. The computer-readable data storage memory of claim 17, further comprising instructions that, when executed by the processing unit of the first electronic computing device, causes the processing unit to:
automatically populate one or more additional customer channels based on the one or more customer channels;
automatically populate one or more additional back office interaction steps based on the one or more customer channels;
analyze the one or more customer channels, the one or more customer interaction steps, and the one or more back office interaction steps;
determine whether steps or components are missing or need correcting; and
if any steps or components are missing or need correction, suggest a correction.

19. The computer-readable data storage memory of claim 18, wherein the customer interaction diagram further comprises:
at least one requirement to the customer interaction diagram, the at least one requirement selected from: a business requirement, a technology requirement, or a miscellaneous requirement; and
at least one note positioned in the first portion or the second portion;
wherein the one or more customer interaction steps are positioned adjacent to the one or more customer-channel lines;
wherein the one or more customer interaction steps are numbered sequentially; and
wherein a directional arrow is positioned adjacent to each of the one or more customer interaction steps.

20. (canceled)

21. The electronic computing device of claim 8, wherein analyzing the one or more back office interaction steps to yield an analysis includes:
mining code of the one or more back office interaction steps using a lexicographic scanner; and
comparing results of the mining with a to-do list for developers and testers of the code.

22. The computer-readable data storage memory of claim 19, wherein analyzing the one or more back office interaction steps to yield an analysis includes:
mining code of the one or more back office interaction steps using a lexicographic scanner; and
comparing results of the mining with a to-do list for developers and testers of the code.
